(19) United States
(12) Patent Application Publication
(10) Pub. No.: US 2010/0332597 A1
(43) Pub. Date: Dec. 30, 2010

(54) METHOD AND SYSTEM FOR REDUCING THE NUMBER OF PRESENCE EVENTS WITHIN A NETWORK

(75) Inventor: Douglas W. Varney, Naperville, IL (US)

Correspondence Address: FAY SHARPE/LUCENT, 1228 Euclid Avenue, 5th Floor, The Halle Building, Cleveland, OH, 44115-1843, US

(73) Assignee: Alcatel-Lucent USA Inc.

(21) Appl. No.: 12/495,308

(22) Filed: Jun. 30, 2009

(51) Int. Cl. G06F 15/173; G06F 15/16

(52) U.S. Cl. 709/204; 709/224

(57) ABSTRACT

A method and apparatus for reducing the number of presence events in a network are provided. This is accomplished by segregating close buddies (on a buddy or contact list) from not-so-close buddies (on the list) for purposes of better managing the flow of presence information in a network.

### BACKGROUND OF THE INVENTION

This invention relates to a method and apparatus for reducing the number of presence events in a network. This is accomplished by segregating the contacts that a person communicates frequently (close buddies/most-recently-used contacts) from those that a person communicates less frequently (not-so-close buddies/less-recently-used contacts) for purposes of better managing the flow of presence information in a network.

While the invention is particularly directed to the art of management of presence information on a network, and will be thus described with specific reference thereto, it will be appreciated that the invention may have usefulness in other fields and applications.

By way of background, there are standards-based mechanisms for facilitating notification of users, known as watchers, about presence information relating to other users known as presentities. Presence information, as is known, may take a variety of forms, but generally is an indicator of a user status. This type of information will allow others to determine if the user is available, busy, . . . etc. Typically, the noted standards-based mechanisms, when the watcher is in a mobile network, use excessive amounts of radio network resources and decrease battery life on mobile devices. Of course, excess use of network resources is undesirable for mobile providers and decreased battery life is not desired by mobile subscribers.

Further, in non-mobile use, the generation and transport of notification of changes of presence status, where each user is watching multiple presentities, results in excessive demands on resources (such as server capacity) that is not desirable to the presence network operator.

In one scenario, presence information is PUSHED to a mobile subscriber automatically upon a change in status of other users (in one form, users in the address book of the subscriber). Even with only tens of presentities being tracked, this approach puts a huge burden on the network because network resources are required for every PUSH of information to the user.

Also, several other existing mechanisms are available to address the difficulties of presence information in a network. For example, a PULL of presence information (instead of a PUSH) could be used. However, this approach degrades the user experience. A time lag (present in many wireless networks) between the request for presence information (e.g. the pull) and delivery may not be acceptable to many users.

The number of states could be reduced, but this approach results in a loss of usefulness for the presence service.

The presence notifications could be throttled. The disadvantages to this approach include delayed delivery and loss of information on short duration events.

A trigger filter may also be implemented. This approach, though, requires a high degree of user involvement to set filters.

Absent other approaches, network providers could simply reduce the number of subscribers receiving presence functionality. This will result in fewer subscribers with the service—possibly reducing revenues.

### SUMMARY OF THE INVENTION

A method and apparatus for reducing the number of presence events in a network are provided.

In one aspect of the presently described embodiments, the method comprises detecting a change in presence status (by, for example, a watcher such as a first user) for a second user (e.g. a presentity), and determining if the second user (e.g. a presentity) is on a first list or a second list, immediately notifying the first user (e.g. a watcher) of the change in presence status if the second user (e.g. a presentity) is on the first list and notifying the first mobile user of the change in presence status upon detection of a predefined event if the second user is on the second list. In another aspect of the presently described embodiments, the first list is a close buddy list/most-recently-used contacts.

In another aspect of the presently described embodiments, the second list contains identifiers of not-so-close buddy list/less-recently-used contacts.

In another aspect of the presently described embodiments, the predefined event is the opening of an address book or contact list.

In another aspect of the presently described embodiments, the method further comprises modifying the first and second lists.

In another aspect of the presently described embodiments, the first user is a watcher.

In another aspect of the presently described embodiments, the second user is a presentity.

In another aspect of the presently described embodiments, the system comprises a first client corresponding to a first user (e.g. a watcher), an XDMS server storing a first list and a second list and a presence server operative to detect a change in presence status for a second user (e.g. a presentity), determine if the second user (e.g. a presentity) is on the first list or the second list, immediately notify the first mobile client (e.g. a watcher) of the change in presence status if the second user (e.g. a presentity) is on the first list and notify the first client of the change in presence status upon detection of a predefined event if the second user (e.g. a presentity) is on the second list.

In another aspect of the presently described embodiments, the first list is a close buddy list.

In another aspect of the presently described embodiments, the second list contains identifiers of users on the not-so-close buddy list/less-recently-used contacts

In another aspect of the presently described embodiments, the predefined event is the opening of an address book or contact list.

In another aspect of the presently described embodiments, at least one of the presence server and the first client (e.g. a watcher) is further operative to modify the first and second lists.

In another aspect of the presently described embodiments, the first user is a watcher.

In another aspect of the presently described embodiments, the second user is a presentity.

Further scope of the applicability of the present invention will become apparent from the detailed description provided below. It should be understood, however, that the detailed description and specific examples, white indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a network into which the presently described embodiments may be implemented;

FIG. 2 is a flow chart of a method according to the presently described embodiments; and,

FIG. 3 is a block diagram of a network into which the presently described embodiments may be implemented.

### DETAILED DESCRIPTION

A basic idea of the presently described embodiments is to provide an advantageous mixture of PUSH and PULL models to achieve a good user experience with minimized use of radio network resources.

In this regard, in one form, a presence PUSH method is used for a small set of buddies, or most frequently called parties, that are determined by communications patterns revealed on the mobile client through a call log/most frequently called-or-communicated list. This set of users will always have their presence status up-to-date according to at least one form of the presently described embodiments.

A presence PULL method is used for the rest of the entries on the address book. This set of users will only have presence updated when it is likely that they will be used (e.g. upon detection of a predefined event such as opening the address book) according to at least one form of the presently described embodiments.

As communication patterns change, the composition of that small set of buddies may be changed so that the small set of entities that the user communicates with are kept constantly up-to-date. The larger set of entities, where communication is infrequent, are updated only when the address book is being opened, or other such event where it is likely that they will be used.

The combination reduces network resources (e.g. much fewer Notify messages that require paging, opening a traffic channel, etc. are used) to deliver up-to-date presence to only a few entities on a subscriber's address book.

In at least one form of the proposed solution, standard SIP/SIMPLE (Session Initiation Protocol/SIP for Instant Messaging and Presence Leveraging Extensions) presence signaling as standardized by IETF, 3GPP, and OMA is used.

In at least one form, a client, such as a mobile client, analyzes its communications log to determine its Close Buddy list. It sets this list within, for example, the XDMS and makes a subscription to that list to, for example, the Presence Server/Resource List Server (RLS). In this form, the Presence Server/RLS notifies the mobile client when there is a change in status to anyone on that list.

Further, in at least one form, when the address book is opened, the client (e.g. a mobile client) makes a request to update the status (using expires=0, a PULL request) for the non-close buddy list.

In at least one form, when changes occur to the Close Buddy list, due to (for example) changes in the communication patterns of the subscriber, the two lists (e.g. Close-Buddy list, and the non-Close Buddy list) are changed to reflect that change.

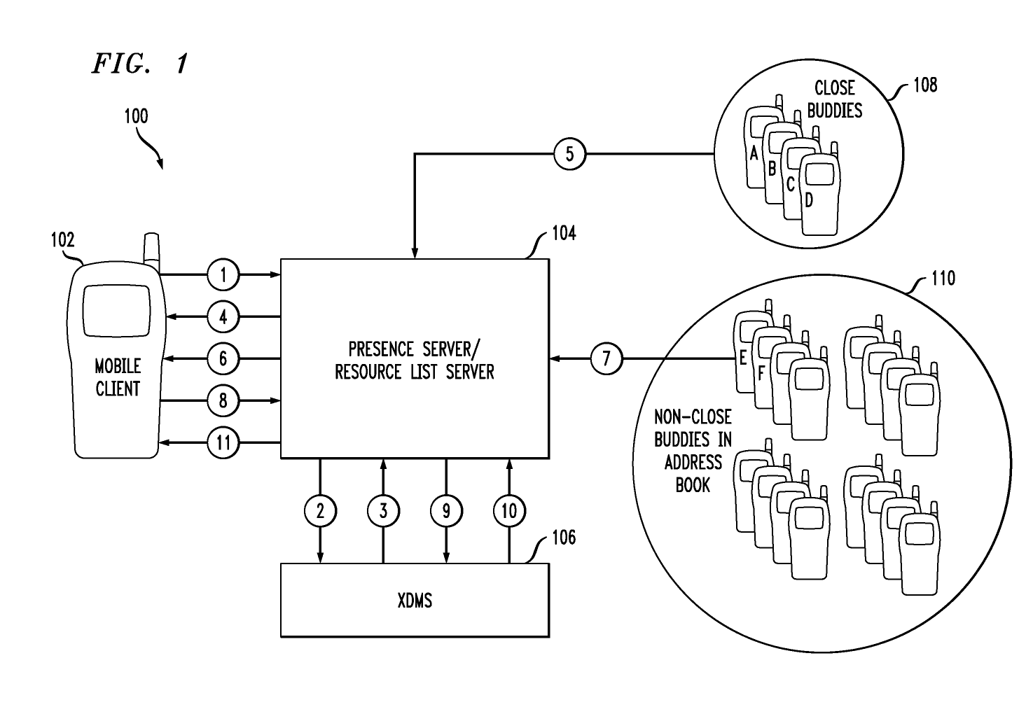

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 illustrates a portion 100 of a network. This portion of the network implements the techniques described herein in connection with the presently described embodiments in which a mixture of push and pull models is provided to enhance user experience in using presence detection techniques with minimized use of network resources. It should be appreciated that only a portion of a network is illustrated for ease of explanation. Those of skill in the art will understand how this portion integrates with other network elements.

In this regard, the network 100 includes, for example, a client 102 (such as a mobile client) that is in communication with a presence server/resource list server 104. The client 102 is illustrated, for example, as a mobile client and may take a variety of forms such as a mobile phone, personal computer, etc. Further, the client 102 may be mobile or not mobile—it may be, for example, a work station or other computing device. In addition, the client 102 is a watcher.

The server 104 is likewise in communication with an XML document management server (XDMS) 106. The XDMS server 106 has stored thereon a variety of pieces of information including at least a first and second list. Among these, a close buddy list 108 and a non-close buddy list 110 are stored. In at least one form, the users on the close buddy list will not be on the non-close buddy list. These lists may comprise, for example, the address book for the user of the client 102 and my contain identifiers or other data relating to other users. In appropriate circumstances, these other users on the lists may be referred to as presentities. Also, the other users may take a variety of forms (e.g. mobile phones, computers, etc.) and/or use a variety of devices and may be mobile or not mobile.

In operation, presence data is pushed to the client on status changes for a small set of buddies. This small set of close buddies, as illustrated by the close buddy list 108, is determined from call logs, or most recently used numbers, communicated on the client 102. This set of close buddies has their presence status constantly up to date for the mobile client 102 by using a push mechanism. It should be appreciated that having only a small set of buddies that is constantly up to date is typically desired by most mobile users. In this regard, for example, mobile phone users typically communicate with only a very small number of people. Therefore, only having a small group of close buddies constantly updated will suffice for most people.

In at least one implementation, the close buddy list will be automatically updated for the client 102 (e.g. mobile client 102) by using standard mechanisms such as XCAP to an XDMS database. In this way, the example mobile client 102, or subscriber to the presence server 104, is notified when any of the entries on the close buddy list changes. It should be appreciated that this feature may be implemented in a variety of ways. For example, an alternative implementation is for the client (e.g. mobile client) to request, or subscribe, to each one of the close buddies individually.

By way of illustration, with further reference to FIG. 1, the process for pushing information for a small set of buddies may take a variety of forms. In one example form, client 102 subscribes to presence information for its close buddy list (reference line 1). Then, the presence server 104 requests members of the close buddy list from the XDMS server 106 (reference line 2). The XDMS server then responds with the identities of buddies A, B, C and D to the presence server 104 (reference line 3). The presence server 104 returns the status of buddies A, B, C and D to the client 102 (reference line 4). At this point, if the status of any of the close buddies (or presentities) changes, the change is detected by the presence server and the presence server will automatically notify the client. For example, if the status of close buddy A (e.g. a presentity) changes, the presence server is notified (reference line 5). Likewise, the presence server then sends a notification of a status change to the client 102 (reference line 6).

As noted above, the presently described embodiments provide a mix of both push and pull models to provide enhanced user experience but limit the use of network resources. Accordingly, pull techniques are used on the larger set of address book entries, identified as non-close buddies 110 in FIG. 1. In this regard, a pull mechanism is used to update entries within the address book that are not included in the close buddy list only when needed. In one form, the non-close buddy list is updated using a standard mechanism such as XCAP (XML Configuration Access Protocol) to an XDMS database. The presence information for each entry on that list is updated using the presence pull mechanism for the list. Of course, alternatives may exist. For example, in one alternative implementation, multiple lists are defined with the entries in the list such that entries that are shown early in the address book are pulled first, while later entries are subsequently pulled. Again, the benefit of this implementation is for better user experience. In another alternative, a presence pull request for each entry in the address book may be made.

As with the pushing techniques, the pulling techniques may be implemented in a variety of ways. However, in one implementation, with reference to FIG. 1, the status of a buddy E (e.g. a presentity) (which may be mobile) changes, so the presence server 104 is updated with the change in status. In this case, because a pull of information to, for example, the mobile client is required, no notification is sent to the mobile client. Then, when the subscriber opens an address book, for example, a pull request is sent to the presence server designating the non-close buddy list (reference line 8). The presence server then requests the members of the non-close buddy list from the XDMS server 106 (reference line 9). The XDMS server 106 responds with the current identities of all non-close buddies including the status of the mobile for buddy E (reference line 10). The presence server then returns the status of these non-close buddies to the client 102 (reference line 11). So, if the change in status is for a user (presentity) on the second list, then the watcher (e.g. first user, or client 102) is not notified on the change in presence status and, instead, the watcher is only updated on the change in status on this presentity when a predefined event occurs.

One of the features of the presently described embodiments is the constant updating of the close buddy list within the client functionality. In this regard, enhancement of the user experience will be provided by the system when the close buddy list is constantly updated.

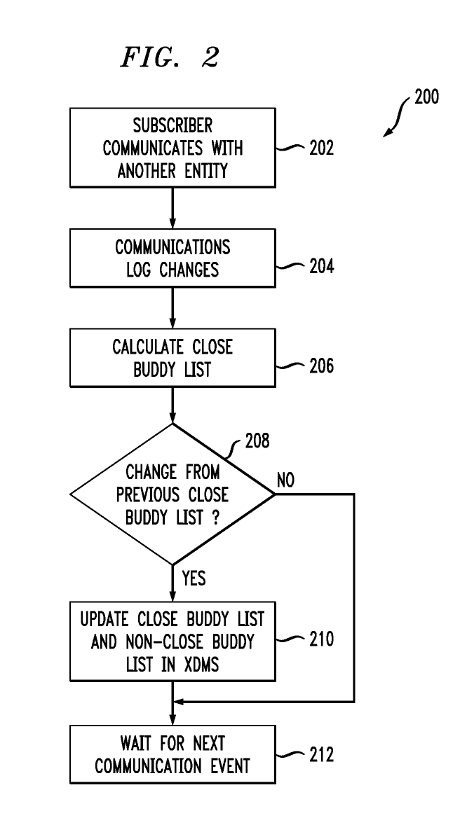

With reference now to FIG. 2, a method 200 is illustrated. In this method, a subscriber communicates with another entity (at 202). In this example, this changes the communications log (at 204). Based on the change in the communications log, the close buddy list is calculated, or recalculated (at 206). The new status of the close buddy list is then compared to the old status to determine if there is a change from one list to the other (at 208). If there was a change, the close buddy lists and the non-close buddy lists that reside on the XDMS server 106 are updated (at 210). The system then waits for the next communication event (at 212). Of course, if there is no change to the buddy list at step 208, the system simply waits for the next communication event (at 212).

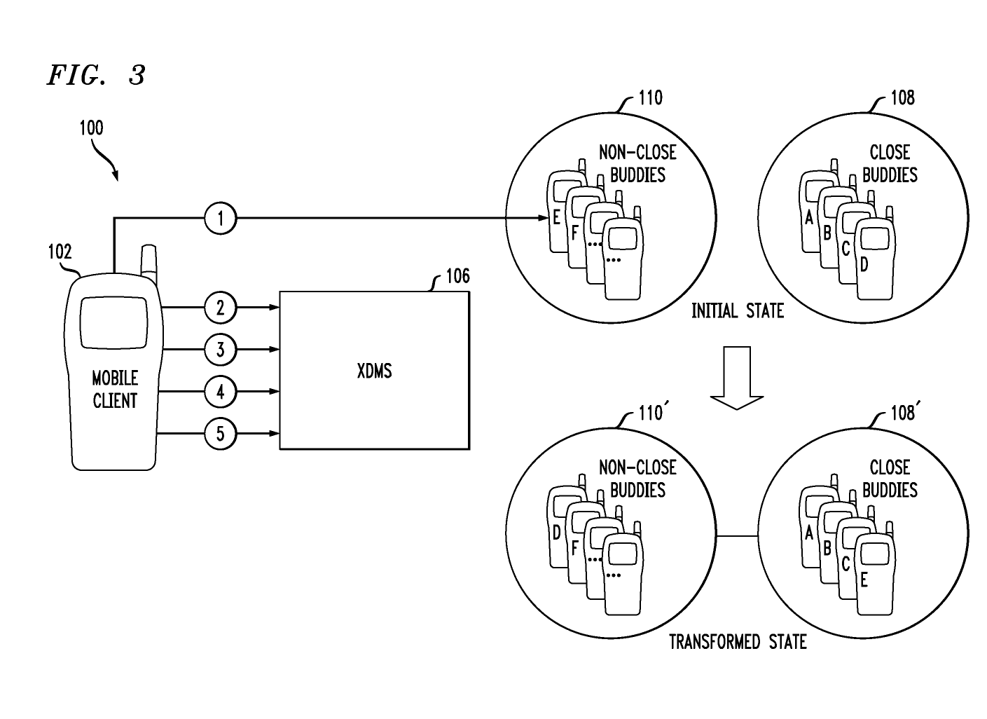

The updating of the close buddy and non-close buddy lists in step 210 can be accomplished in a variety of manners. In one exemplary form, with reference now to FIG. 3, system 100 is illustrated. In this example, the subscriber or mobile client 102 sends a text message to a buddy E. In this example, E becomes one of the top four buddies, replacing D (reference line 1). The client sends XCAP Put with E to close buddy XDMS list (reference line 2). The mobile client 102 then sends XCAP Put with D to non-close buddy list (reference line 3). The mobile client then sends the XCAP Delete with D to close buddy list 108 (reference line 4). Last, the mobile client sends XCAP Delete with E to non-close buddy list 110 (reference line 5). Once all these actions are taken, initial state of the close buddy list and the non-close buddy list 108 and 110, respectively, are changed to a transform state, as illustrated by close buddy list 108′ and non-close buddy list 110′.

It should be appreciated that the methods and techniques described herein may be implemented using a variety of software routines, hardware configurations and/or combinations of both. For example, the techniques described in connection with FIGS. 1, 2 and 3 may be implemented using software routines run on the client or mobile client, presence server, the XDMS server, or various combinations thereof. Further, it should be appreciated that these elements may take a variety of forms, e.g. they may be incorporated within other elements or may be stand-alone entities.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for notifying a first user of presence status changes for other users, the method comprising:
detecting a change in presence status for a second user;
determining if the second user is on a first list or a second list;
immediately notifying the first user of the change in presence status if the second user is on the first list; and,
notifying the first user of the change in presence status upon detection of a predefined event if the second user is on the second list.

2. The method as set forth in claim 1 wherein the first list is a close buddy list.

3. The method as set forth in claim 2 wherein the second list contains identifiers of mobile users not on the close buddy list.

4. The method as set forth in claim 1 wherein the predefined event is the opening of an address book or contact list.

5. The method as set forth in claim 1 further comprising modifying the first and second lists.

6. The method as set forth in claim 1 wherein the first user is a watcher.

7. The method as set forth in claim 1 wherein the second user is a presentity.

8. A system for notifying a first user of presence status changes for other users, the system comprising:
a first client corresponding to the first user;
an XDMS server storing a first list and a second list; and,
a presence server operative to detect a change in presence status for a second user, determine if the second user is on the first list or the second list, immediately notify the first client of the change in presence status if the second user is on the first list and notify the first client of the change in presence status upon detection of a predefined event if the second user is on the second list.

9. The system as set forth in claim 8 wherein the first list is a close buddy list.

10. The system as set forth in claim 9 wherein the second list contains identifiers of mobile users not on the close buddy list.

11. The system as set forth in claim 8 wherein the predefined event is the opening of an address book or contact list.

12. The system as set forth in claim 8 wherein at least one of the presence server and the first client is further operative to modify the first and second lists.

13. The system as set forth in claim 8 wherein the first client is a watcher.

14. The system as set forth in claim 8 wherein the second user is a presentity.

15. A system for notifying a first user of presence status changes for other users, the system comprising:
means for detecting a change in presence status for a second user;
means for determining if the second user is on a first list or a second list;
means for immediately notifying the first user of the change in presence status if the second user is on the first list; and,
means for notifying the first mobile user of the change in presence status upon detection of a predefined event if the second user is on the second list.

16. The system as set forth in claim 15 wherein the first list is a close buddy list.

17. The system as set forth in claim 16 wherein the second list contains identifiers of mobile users not on the close buddy list.

18. The system as set forth in claim 15 wherein the predefined event is the opening of an address book or contact list.

19. The system as set forth in claim 15 further comprising modifying the first and second lists.

20. The system as set forth in claim 15 wherein the second user is a presentity.
